(19) United States
(12) Patent Application Publication
(10) Pub. No.: US 2026/0225065 A1
(43) Pub. Date: Aug. 6, 2026

(54) PREPARATION METHOD FOR TITANIUM-BASED LITHIUM ION SIEVE, PRODUCT PREPARED THEREBY, AND USE

(71) Applicant: BEIJING HUATEYUAN TECHNOLOGY CO., LTD., Beijing (CN)

(72) Inventors: Tianyu LI, Beijing (CN); Hengliang MO, Beijing (CN); Peng XIE, Beijing (CN); Jianglong HUANG, Beijing (CN); Long LV, Beijing (CN); Chunsheng CHEN, Beijing (CN); Zhibo XU, Beijing (CN); Hengyu YANG, Beijing (CN); Manman LIU, Beijing (CN); Xiaofeng ZHU, Beijing (CN); Bin SHAO, Beijing (CN)

(21) Appl. No.: 19/146,315

(22) PCT Filed: Jun. 29, 2023
(86) PCT No.: PCT/CN2023/104256

§ 371 Date: Jul. 8, 2025

(30) Foreign Application Priority Data
Jun. 8, 2023 (CN) 202310679048.9

(51) Int. Cl. B01J 20/04; C02F 1/28; C02F 101/10; C02F 103/00

(52) U.S. Cl. CPC B01J 20/041; C02F 1/281; B01J 2220/46; C02F 2101/10; C02F 2103/007

(57) ABSTRACT

Provided is a preparation method for a titanium-based lithium ion sieve, a product prepared thereby, and a use. The preparation method for a titanium-based lithium ion sieve comprises the following steps: mixing a water-soluble lithium source, a titanium source, and a tackifier, and sequentially carrying out ball milling and sanding to obtain a mixture slurry of the lithium source and the titanium source; drying the mixed slurry and then carrying out crushing to obtain a material to be calcined; and using a segmentation method to carry out high-temperature calcination on said material, and then carrying out crushing to obtain a titanium-based lithium ion sieve, wherein the high-temperature calcination temperature range is divided into four zones, i.e., a heating zone, a high-temperature reaction zone, a medium-temperature reaction zone, and a cooling zone.

### CROSS-REFERENCE TO RELATED APPLICATION

The present disclosure claims priority to Chinese patent application with the filing No. 202310679048.9 filed with the China National Intellectual Property Administration on Jun. 8, 2023, and entitled “PREPARATION METHOD FOR TITANIUM-BASED LITHIUM ION SIEVE, PRODUCT PREPARED THEREBY, AND USE”, the contents of which are incorporated herein by reference in entirety.

### TECHNICAL FIELD

The present disclosure relates to the technical field of lithium ion adsorption, and particularly to a preparation method for a titanium-based lithium ion sieve, a product prepared thereby and use.

### BACKGROUND ART

Since the advent of new energy technologies, lithium batteries have become the dominant power source of new energy. Lithium is widely used in various electronic and electric products. Particularly the surge in new energy vehicles in recent years has elevated lithium resources to become white petroleum in the new era. Although China ranks the fourth in lithium reserves in the world, they predominantly exist in the form of salt lakes, and only through a complex process can lithium be extracted. In recent years, with the research and development of new lithium adsorbents and extractants and application of membrane process, China's salt lake lithium extraction technologies have advanced rapidly. Currently, the domestic salt lake lithium extraction technologies still mainly rely on composite technology of combining lithium adsorbent with membrane, and thus the technical breakthrough in lithium adsorbent is critical.

At present, synthesis of the titanium-based lithium ion sieve mainly employs a high-temperature solid-phase method, which method boasts simple process, convenient operation, and easy scale-up production. The high-temperature solid-phase synthesis of titanium-based lithium ion sieve involves procedures of “mixing a lithium source and a titanium source”, “drying materials”, “pulverizing intermediate materials”, “high-temperature calcination” and “pulverizing a finished product”, in which procedures, non-uniform material mixing, material segregation during drying and improper sintering process during sintering tend to occur to cause problems of inconsistent and low performance of titanium-based lithium ion sieve products.

CN115069209A discloses a titanium lithium ion sieve inorganic composite adsorption lithium extraction material and a preparation method thereof. The method includes mixing a titanium lithium ion sieve or a precursor thereof with a regulator, a curing agent and a resin monomer, and carrying out polymerization reaction on polymer monomer at a certain temperature and gradually curing, in which process, a granular material in a specific shape is prepared through extrusion or spray drying, then carrying out high-temperature roasting under an anaerobic condition, and carrying out acid treatment to obtain a carbon-supported titanium lithium ion sieve inorganic/inorganic composite lithium extraction material.

CN114345291A discloses a preparation method for a high-adsorption-capacity granular titanium-based lithium ion sieve adsorbent. This method includes step 1, preparing titanium-based lithium ion sieve precursor powder; step 2, preparing a high-adsorption-capacity titanium-based lithium ion sieve adsorbent: 1) pre-treatment on the precursor powder; 2) preparation of composite adhesive; 3) doping, blending and homogenization; 4) molding by granulation; and 5) elution and replacing. The granular adsorbent has high porosity, exhibits good suspension performance during lithium extraction from salt lake brine or simulated brine, and has a fast adsorption-desorption rate and high lithium extraction activity. However, lithium carbonate as lithium source in this patent tends to have the problem of non-uniform material mixing, which is particularly prominent in industrialization and scale-up production.

Therefore, to address the problem of non-uniform material mixing, two powder materials cannot be mixed directly in a dry state; to address the problem of material segregation of in the drying process, a mixed feed liquid needs to have a certain viscosity, so as to reduce sedimentation of the powder materials; and to address the problem of low product performance caused by an improper sintering process during the sintering, calcination temperature and calcination time should be optimized so as to align with reaction thermodynamic and kinetic parameters in titanium-based lithium ion sieve synthesis.

### SUMMARY

The present disclosure provides a preparation method for a titanium-based lithium ion sieve, so as to address the problems of non-uniform material mixing, material segregation during drying, and low product performance caused by an improper sintering process during sintering in the related art.

The present disclosure further provides a titanium-based lithium ion sieve prepared by the above method, where the titanium-based lithium ion sieve has a quite small and uniform particle size, and high adsorption capacity.

The present disclosure further provides a use of the above titanium-based lithium ion sieve in selective recognition and/or extraction of lithium ions from brine. The above titanium-based lithium ion sieve has extremely high selectivity for lithium ions, can selectively extract lithium ions from brine, and substantially does not adsorb potassium, sodium, magnesium and calcium ions.

Some embodiments of the present disclosure provide a preparation method for a titanium-based lithium ion sieve, so as to at least solve the technical problems existing in the related art.

The preparation method for a titanium-based lithium ion sieve provided in embodiments of the present disclosure may include steps as follows:
(1) mixing a water-soluble lithium source, a titanium source and a thickener (tackifier), and sequentially carrying out ball milling and sand milling, so as to yield a mixed slurry of the lithium source and the titanium source;
(2) drying the mixed slurry obtained in step (1) and then carrying out pulverization (crushing), so as to yield a material to be calcined; and
(3) carrying out high-temperature calcination on the material to be calcined obtained in step (2) by segmentation, followed by pulverization, so as to yield the titanium-based lithium ion sieve.

A temperature range of the high-temperature calcination is partitioned into four zones, including a heating zone, a high-temperature reaction zone, a medium-temperature reaction zone and a cooling zone, where a temperature setting for the heating zone is 100-750° C. (which may be, for example, 100° C., 150° C., 200° C., 250° C., 300° C., 350° C., 400° C., 450° C., 500° C., 550° C., 600° C., 650° C., 700° C., and 750° C.), a temperature setting for the high-temperature reaction zone is 950-1050° C. (which may be, for example, 950° C., 980° C., 1000° C., and 1050° C.), a temperature setting for the medium-temperature reaction zone is 800-900° C. (which may be, for example, 800° C., 820° C., 840° C., 860° C., 880° C., and 900° C.), and a temperature setting for the cooling zone is 150-650° C. (which may be, for example, 150° C., 200° C., 250° C., 300° C., 350° C., 400° C., 450° C., 500° C., 550° C., 600° C., and 650° C.).

In step (1) in the present disclosure, the water-soluble lithium source instead of the water-insoluble lithium source (such as lithium carbonate) is used as the lithium source and mixed with the titanium source, and the water-soluble lithium source infiltrates and coats on a surface of titanium dioxide, so that the lithium source and the titanium source can be mixed more sufficiently, thus shortening a migration path of lithium ions during the reaction, and elevating the reaction rate.

In step (3) of the present disclosure, sintering is carried out in a pusher kiln, and a temperature range of the pusher kiln is partitioned into four zones: a heating zone, a high-temperature reaction zone, a medium-temperature reaction zone and a cooling zone.

The material will undergo the following reaction in the process:

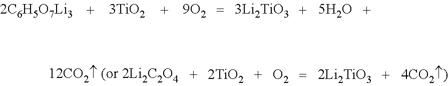

Herein, short residence time in the high-temperature reaction zone is designed mainly to allow reactants to react and nucleate in the high-temperature zone, generating a large quantity of nascent crystal nuclei, and then the reactants enter the medium-temperature reaction zone, to allow these crystal nuclei to grow more regularly and completely in the medium-temperature zone, thus facilitating improving the adsorption capacity and selectivity. The calcination temperature and calcination time are optimized so as to align with reaction thermodynamic and kinetic parameters in titanium-based lithium ion sieve synthesis, thus solving the problem of low product performance caused by an improper sintering process during the sintering.

Optionally, in step (1), a mass ratio of the water-soluble lithium source, the titanium source and the thickener is (1-5):(1-5):(0.01-0.05).

The first “1-5” herein may be, for example, 1, 2, 3, 4, and 5.

The second “1-5” herein may be, for example, 1, 2, 3, 4, and 5.

“0.01-0.05” herein may be, for example, 0.01, 0.02, 0.03, 0.04, and 0.05.

Optionally, the water-soluble lithium source is a lithium citrate solution and/or a lithium oxalate solution.

Optionally, the water-soluble lithium source is prepared by a method as follows: adding lithium hydroxide into water under stirring, then adding acid, and stirring to yield a water-soluble lithium source solution.

Optionally, a mass ratio of the water, lithium hydroxide and acid is (3-5):(1.5-2):(3.5-4.5).

“3-5” herein may be, for example, 3, 3.5, 4, 4.5, and 5.

“1.5-2” herein may be, for example, 1.5, 1.6, 1.7, 1.8, 1.9, and 2.

“3.5-4.5” herein may be, for example, 3.5, 3.6, 3.8, 4, 4.2, and 4.5.

Optionally, the acid includes citric acid and/or oxalic acid.

More specifically, the water-soluble lithium source is prepared by methods as follows.

### (1) Preparation of Lithium Citrate Solution:

adding deionized water into an agitator, adding a lithium hydroxide powder under stirring, adding a citric acid powder, and stirring at a rotational speed of 100-600 rpm (which may be, for example, 100 rpm, 200 rpm, 300 rpm, 400 rpm, and 500 rpm) for 1-3 h (which may be, for example, 1 h, 1.5 h, 2 h, 2.5 h, and 3 h), so as to yield the lithium citrate solution. A reaction equation of this process is: C₆H₈O₇+3LiOH=C₆H₅O₇Li₃+3H₂O;

### (2) Preparation of Lithium Oxalate Solution:

adding deionized water into an agitator, adding a lithium hydroxide powder under stirring, adding an oxalic acid dihydrate powder, and stirring at a rotational speed of 100-600 rpm (which may be, for example, 100 rpm, 200 rpm, 300 rpm, 400 rpm, and 500 rpm) for 1-3 h (which may be, for example, 1 h, 1.5 h, 2 h, 2.5 h, and 3 h), so as to yield the lithium oxalate solution. A reaction equation of this process is: H₂C₂O₄·2H₂O+2LiOH=Li₂C₂O₄+4H₂O.

Optionally, in step (1), the titanium source includes rutile type titanium dioxide and/or anatase type titanium dioxide.

Optionally, in step (1), a particle size of the titanium source is 50-500 nm, for example, 50 nm, 60 nm, 80 nm, 100 nm, 120 nm, 150 nm, 200 nm, 250 nm, 300 nm, 350 nm, 400 nm, 450 nm, and 500 nm.

In step (1) in the present disclosure, optionally, rutile type titanium dioxide (or anatase type titanium dioxide) with a nanoscale particle size tends to agglomerate in an aqueous solution, and agglomerated titanium dioxide is ground and broken up by the process of first ball milling and then sand milling in the aqueous phase system, so that the titanium dioxide particles are in more sufficient contact with the water-soluble lithium source, and at the same time, the two materials can be mixed more uniformly, which is conducive to uniformity of product performance.

Optionally, in step (1), the thickener includes any one selected from the group consisting of polyethylene glycol, polyvidone, polyvinyl alcohol or hydroxyethyl cellulose or a combination of at least two therefrom, further optionally polyethylene glycol.

Optionally, a number-average molecular weight of the polyethylene glycol is 200-800, for example, 200, 300, 400, 500, 600, 700, and 800, and further optionally 400-600.

In step (1) of the present disclosure, polyethylene glycol is optionally employed as the thickener, further optionally PEG-400 (or PEG-600). This is because, compared with other types of thickeners, they not only increase viscosity of the feed liquid to prevent sedimentation of titanium dioxide in the aqueous solution, and ensure uniform dispersion of the two materials, i.e., the water-insoluble lithium source and the titanium source, without stratification during the microwave drying, but also can maintain the viscosity of the feed liquid within a proper range of 200-500 mPas, thereby avoiding excessively high viscosity that would hinder ball milling and sand milling.

Optionally, in step (1), the lithium source, the titanium source and the thickener are mixed at a rotational speed of 100-600 rpm (which may be, for example, 100 rpm, 200 rpm, 300 rpm, 400 rpm, and 500 rpm) for 2-4 h, for example, 2 h, 2.5 h, 3 h, 3.5 h, and 4 h.

Optionally, in step (1), the ball milling is carried out with zirconia beads with a diameter of 2-8 mm (which may be, for example, 3 mm, 4 mm, 5 mm, 6 mm, 7 mm, and 8 mm) at a rotational speed of 30-90 rpm (which may be, for example, 30 rpm, 40 rpm, 50 rpm, 60 rpm, 70 rpm, 80 rpm, and 90 rpm) for 3-5 h, for example, 3 h, 3.5 h, 4 h, 4.5 h, and 5 h.

Optionally, in step (1), after the ball milling, the feed liquid is fed unidirectionally into a sand mill at a feed rate of 10-20 L/min (which may be, for example, 10 L/min, 12 L/min, 14 L/min, 16 L/min, 18 L/min, and 20 L/min) for grinding; and

Optionally, in step (1), the sand milling is carried out at a rotational speed of 500-1000 rpm (which may be, for example, 500 rpm, 600 rpm, 700 rpm, 800 rpm, 900 rpm, and 1000 rpm) for 5-10 cycles, for example, 5 cycles, 6 cycles, 7 cycles, 8 cycles, 9 cycles, and 10 cycles.

Optionally, in step (2), the drying is microwave drying.

In step (2) of the present disclosure, the microwave drying is selected because using the microwave dryer for drying the liquid material can prevent stratification or sedimentation phenomenon of the water-soluble lithium source solution and titanium dioxide caused by prolonged drying time, thus ensuring uniform dispersion of the material and improving drying efficiency.

Optionally, in step (2), a feed rate of the mixed slurry is 80-100 kg/h, for example, 80 kg/h, 85 kg/h, 90 kg/h, 95 kg/h, and 100 kg/h.

Optionally, in step (2), the microwave drying is carried out at a power of 100-200 kW, for example, 100 kW, 120 kW, 140 kW, 160 kW, 180 kW, and 200 kW; and the microwave drying lasts for 0.5-1 h, for example, 0.5 h, 0.6 h, 0.7 h, 0.8 h, 0.9 h, and 1 h.

Optionally, in step (2), a moisture content of the material to be calcined is 0.1%-0.5%, for example, 0.1%, 0.2%, 0.3%, 0.4%, and 0.5%.

Optionally, in step (2), sieving is needed after the pulverization, further optionally through a 50-100 mesh (50-mesh, 60-mesh, 70-mesh, 80-mesh, 90-mesh, and 100-mesh) sieve.

Optionally, in step (3), the high-temperature calcination is carried out in a pusher kiln, followed by the pulverization, so as to yield the titanium-based lithium ion sieve.

Optionally, in step (3), a total length of the pusher kiln is 28-42 m, for example, 28 m, 30 m, 32 m, 34 m, 36 m, 38 m, 40 m, and 42 m.

Optionally, in step (3), the heating zone is partitioned into five segments, each with a length of 2-3 m (which may be, for example, 2 m, 2.2 m, 2.4 m, 2.5 m, 2.6 m, 2.8 m, and 3 m), temperature settings for the five segments of the heating zone are 100-150° C., 250-300° C., 400-450° C., 550-600° C., and 700-750° C. in sequence, and total residence time of the material in the heating zone is 4-5 h (which may be, for example, 4 h, 4.2 h, 4.6 h, 4.8 h, and 5 h).

Optionally, in step (3), the high-temperature reaction zone has one segment, with a length of 2-3 m (which may be, for example, 2 m, 2.2 m, 2.4 m, 2.5 m, 2.6 m, 2.8 m, and 3 m), a temperature setting for the high-temperature reaction zone is 950-1050° C., and residence time of the material in the high-temperature reaction zone is 0.8-1 h (which may be, for example, 0.8 h, 0.85 h, 0.9 h, 0.95 h, and 1 h).

Optionally, in step (3), the medium-temperature reaction zone is partitioned into four segments, each with a length of 2-3 m (which may be, for example, 2 m, 2.2 m, 2.4 m, 2.5 m, 2.6 m, 2.8 m, and 3 m), temperature settings for the four segments of the medium-temperature reaction zone are 800-900° C., 800-900° C., 800-900° C., and 800-900° C. in sequence, and total residence time of the material in the medium-temperature reaction zone is 3.2-4 h (which may be, for example, 3.2 h, 3.4 h, 3.6 h, 3.8 h, and 4 h).

Optionally, in step (3), the cooling zone is partitioned into four segments, each with a length of 2-3 m (which may be, for example, 2 m, 2.2 m, 2.4 m, 2.5 m, 2.6 m, 2.8 m, and 3 m), temperature settings for the four segments of the cooling zone are 600-650° C., 450-500° C., 300-350° C., and 150-200° C. in sequence, and total residence time of the material in the cooling zone is 3.2-4 h (which may be, for example, 3.2 h, 3.4 h, 3.6 h, 3.8 h, and 4 h).

In the present disclosure, through the above further optional settings of the temperature range of the pusher kiln, specifically as shown in FIG. 1, the calcination temperature and the calcination time are optimized to align with the reaction thermodynamic and kinetic parameters of the titanium-based lithium ion sieve synthesis, nucleation occurs in the high-temperature zone, and nuclei growth and crystal form perfection proceed in the medium-temperature zone.

Following preheating in the first five segments of the heating zone, the material enters the high-temperature zone. During the reaction of the lithium source and the titanium source, lithium ions in the lithium source migrate into titanium dioxide crystals. Thermodynamic analysis of reaction reveals that initial intercalation and occupation of lithium ions on titanium dioxide crystals require substantial reaction energy (activation energy). Higher temperatures facilitate the formation of nascent transition-state structures between the lithium ions and the titanium dioxide. Explosive formation of a large amount of nascent transition-state structures promotes the formation of more lithium intercalation sites, thereby enhancing the adsorption capacity of the synthesized titanium-based lithium ion sieve. The material should not remain in the high-temperature zone for an excessively long time, otherwise, the material tends to form oversized crystals at high temperatures, thereby reducing the adsorption capacity.

Subsequently, the material enters into the four segments of the medium-temperature reaction zone. Reaction of the material in the medium-temperature reaction zone mainly involves secondary growth and crystal perfection of the transition-state structures formed in the high-temperature zone. Thermodynamic analysis of reaction reveals that the secondary growth and crystal perfection require lower temperatures and longer time. Lower temperatures promote independent growth and perfection of the crystals under a condition of obtaining proper energy, instead of agglomerative growth perfection under high temperature and high energy. Extended time enables thorough migration of lithium ions within the crystals in the titanium dioxide to form a perfect crystal structure, which is beneficial to improving selectivity of the titanium-based lithium ion sieve. The calcination temperature and the calcination time are optimized to align with the reaction thermodynamic and kinetic parameters of the titanium-based lithium ion sieve synthesis, thus solving the problem of low product performance caused by an improper sintering process during the sintering.

Optionally, in step (3), sieving is needed after the pulverization, further optionally through a 100-200 mesh (which may be, for example, 100-mesh, 120-mesh, 150-mesh, 180-mesh, and 200-mesh) sieve.

Some other embodiments of the present disclosure provide a titanium-based lithium ion sieve, where the titanium-based lithium ion sieve is prepared by the preparation method for a titanium-based lithium ion sieve according to some embodiments of the present disclosure.

A crystal form of the titanium-based lithium ion sieve prepared by the preparation method according to some embodiments of the present disclosure is β-Li₂TiO₃ crystal form. The titanium-based lithium ion sieve synthesized through this process has a single crystal form, without other impurities.

Some other embodiments of the present disclosure provide a use of the titanium-based lithium ion sieve according to the some other embodiments in the above in selective recognition and/or extraction of lithium ions from brine.

Compared with the prior art, the present disclosure at least has following beneficial effects.

(1) In the present disclosure, the water-soluble lithium source instead of the water-insoluble lithium source is used as the lithium source, and mixed with the water-insoluble titanium source, and the water-soluble lithium citrate infiltrates and coats on a surface of titanium dioxide, so that the lithium source and the titanium source can be mixed more sufficiently, thus shortening a migration path of lithium ions during the reaction, and elevating the reaction rate.

(2) The optional rutile type titanium dioxide (or anatase type titanium dioxide) with a nanoscale particle size tends to agglomerate in an aqueous solution, and agglomerated titanium dioxide is ground and broken up by the process of first ball milling and then sand milling in the aqueous phase system, so that the titanium dioxide particles are in more sufficient contact with the water-soluble lithium citrate, and at the same time, the two materials can be mixed more uniformly, which is conducive to uniformity of product performance.

(3) By adding the thickener in the present disclosure, the viscosity of the feed liquid is increased, which prevents sedimentation of titanium dioxide in the aqueous solution, and ensures uniform dispersion of the two materials, i.e., lithium citrate and titanium dioxide, without stratification during the microwave drying.

(4) Using the microwave dryer for drying the liquid material in the present disclosure can prevent the stratification or sedimentation phenomenon of the lithium citrate solution and titanium dioxide caused by prolonged drying time, thus ensuring uniform dispersion of the material and improving drying efficiency.

(5) The sintering is carried out in the pusher kiln in the present disclosure, and the temperature range of the pusher kiln is partitioned into four zones: the heating zone, the high-temperature reaction zone, the medium-temperature reaction zone and the cooling zone. The short residence time in the high-temperature reaction zone is designed mainly to allow reactants to react and nucleate in the high-temperature zone, generating a large quantity of nascent crystal nuclei, and then the reactants enter the medium-temperature reaction zone, to allow these crystal nuclei to grow more regularly and completely in the medium-temperature zone, thus facilitating improving the adsorption capacity and selectivity. The calcination temperature and the calcination time are optimized so as to align with the reaction thermodynamic and kinetic parameters in the titanium-based lithium ion sieve synthesis, thus solving the problem of low product performance caused by an improper sintering process during the sintering.

### BRIEF DESCRIPTION OF DRAWINGS

In order to more clearly illustrate technical solutions in embodiments of the present disclosure or the related art, drawings which need to be used in the description of the embodiments or the prior art will be briefly introduced below. Apparently, the drawings in the following description show some embodiments of the present disclosure, and those ordinarily skilled in the art still could obtain other drawings in light of these drawings, without using any inventive efforts.

FIG. 1 is diagram of temperature zone layout and temperature settings for a pusher kiln provided in the present disclosure.

FIG. 2 is an SEM photograph of a titanium-based lithium ion sieve prepared according to Example 1 of the present disclosure.

FIG. 3 is an XRD pattern of the titanium-based lithium ion sieve prepared according to Example 1 of the present disclosure.

FIG. 4 is a graph of adsorption capacity of samples of the titanium-based lithium ion sieve at different time intervals during calcination, as provided according to Example 1 of the present disclosure.

FIG. 5 is an SEM photograph of a titanium-based lithium ion sieve prepared according to Example 2 of the present disclosure.

FIG. 6 is an XRD pattern of the titanium-based lithium ion sieve prepared according to Example 2 of the present disclosure.

FIG. 7 is a graph of adsorption capacity of samples of the titanium-based lithium ion sieve at different time intervals during calcination, as provided according to Example 2 of the present disclosure.

FIG. 8 is an SEM photograph of a titanium-based lithium ion sieve prepared according to Example 3 of the present disclosure.

FIG. 9 is an XRD pattern of the titanium-based lithium ion sieve prepared according to Example 3 of the present disclosure.

FIG. 10 is a graph of adsorption capacity of samples of the titanium-based lithium ion sieve at different time intervals during calcination, as provided according to Example 3 of the present disclosure.

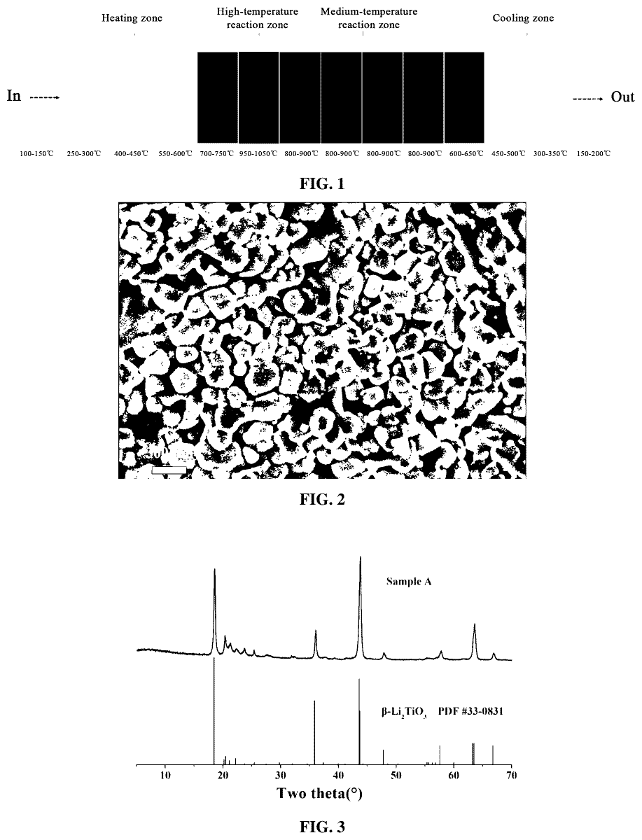

### DETAILED DESCRIPTION OF EMBODIMENTS

Unless otherwise defined herein, scientific and technical terms used in the present disclosure should have meanings that are commonly understood by those ordinarily skilled in the art. The meanings and scopes of the terms should be clear, while in the case of any potential ambiguity, the definitions provided herein take precedence over any dictionary or foreign definitions. In the present disclosure, use of “or” means “and/or” unless otherwise stated. In addition, use of the term “comprise” and other forms is non-limiting.

Generally, nomenclature and techniques used in conjunction with cell and tissue culture, molecular biology, immunology, microbiology, genetics and protein and nucleic acid chemistry and hybridization described herein are those well-known and routinely employed in the art. Unless otherwise stated, the methods and techniques in the present disclosure are generally carried out according to conventional methods well-known in the art and as described in various general and more specific references, and the references are cited and discussed throughout the present specification. Enzymatic reactions and purification technologies are carried out according to the manufacturer's instructions, as commonly implemented in the art or as described herein. Nomenclature used for analytical chemistry, synthetic organic chemistry and medical and pharmaceutical chemistry described herein, as well as laboratory procedures and technologies, are those well-known and commonly used in the art.

Technical solutions of the present disclosure will be described below clearly and completely in conjunction with examples, and apparently, only some but not all examples of the present disclosure are described. All of other examples obtained by those ordinarily skilled in the art based on the examples in the present disclosure without using any inventive efforts shall fall within the scope of protection of the present disclosure.

The present disclosure will be further described below with examples. Unless otherwise specified, materials in the examples were prepared according to existing methods, or purchased directly from the market.

### Example 1

The present example provided a preparation method for a titanium-based lithium ion sieve. The preparation method for a titanium-based lithium ion sieve included steps as follows.

(1) 350 kg of deionized water was added into a mixing tank, 140 kg of a lithium hydroxide powder was added under stirring, and then 380 kg of a citric acid powder was added, followed by stirring at a rotational speed of 100 rpm for 1 h, yielding a lithium citrate solution;

5 kg of PEG-400 and 240 kg of a rutile type titanium dioxide powder (with a particle size of 50 nm) were added into the lithium citrate solution, followed by stirring at a rotational speed of 100 rpm for 2 h, yielding a feed liquid with a viscosity of 200 mPas; subsequently the feed liquid was transferred into a ball mill, and subjected to ball milling with 2 mm-diameter zirconia beads as grinding bodies at a rotational speed of 30 rpm for 3 h; afterwards, the feed liquid was fed unidirectionally into a sand mill at a feed rate of 10 L/min and ground at a rotational speed of 500 rpm, where a material discharged from the sand mill was collected in a separate mixing tank, and the sand milling was carried out for 5 cycles, yielding a mixed slurry of a lithium source and a titanium source;

(2) The above mixed slurry of the lithium source and the titanium source was fed onto a conveyor belt of a microwave dryer (with power of 150 kW), and the mixed slurry was dried in the microwave dryer for 0.5 h, where a feed rate of the mixed slurry was 80 kg/h, and a moisture content of the microwave-dried dry-state lump material was 0.1%; subsequently, the dry-state lump material was pulverized in a pulverizer, and sieved through a 50-mesh sieve, yielding a dry-state powder material to be calcined;

(3) The dry-state powder material to be calcined was loaded into mullite crucibles, with 3 kg in each crucible, and subjected to high-temperature calcination in a pusher kiln. A total length of the pusher kiln was 35 m. A temperature range of the pusher kiln was partitioned into four zones: a heating zone, a high-temperature reaction zone, a medium-temperature reaction zone and a cooling zone. The heating zone was partitioned into five segments, each with a length of 2.5 m, temperature settings for the five segments were 100° C., 250° C., 400° C., 550° C., and 700° C., respectively, and total residence time of the material in the heating zone was 4 h; subsequently, the material entered the high-temperature reaction zone, where the high-temperature reaction zone had only one segment, with a length of 2.5 m, a temperature setting for the high-temperature segment was 950° C., and residence time of the material in the high-temperature zone was 0.8 h; afterwards, the material entered the medium-temperature reaction zone, where the medium-temperature reaction zone was partitioned into four segments, each with a length of 2.5 m, temperature settings for the four segments were 800° C., 800° C., 800° C., and 800° C., respectively, and total residence time of the material in the medium-temperature reaction zone was 3.2 h; then the material entered the cooling zone, where the cooling zone was partitioned into four segments, each with a length of 2.5 m, temperature settings for the four segments were 600° C., 450° C., 300° C., and 150° C., respectively, and total residence time of the material in the medium-temperature reaction zone was 3.2 h; and

Finally, the calcined material was pulverized in the pulverizer and sieved through a 100-mesh sieve, yielding a titanium-based lithium ion sieve powder.

FIG. 2 is an SEM photograph of the titanium-based lithium ion sieve prepared according to Example 1 of the present disclosure. As can be seen from FIG. 2, the titanium-based lithium ion sieve prepared in Example 1 had a particle size of 100-300 nm, which was quite small and uniform, thus being beneficial to improving the adsorption capacity of the titanium-based lithium ion sieve.

FIG. 3 is an XRD pattern of the titanium-based lithium ion sieve prepared according to Example 1 of the present disclosure. As can be seen from FIG. 3, a crystal form of the titanium-based lithium ion sieve is β-Li₂TiO₃ crystal form, demonstrating that the titanium-based lithium ion sieve prepared in Example 1 has a single crystal form, without other impurities.

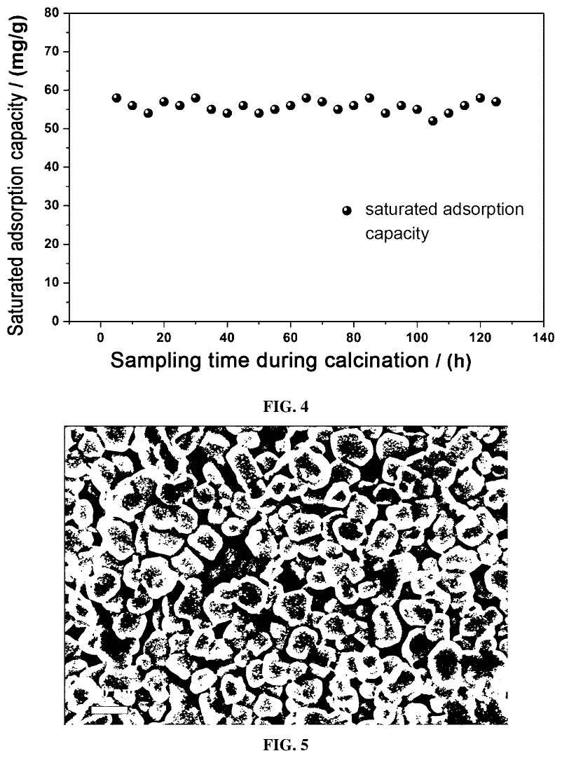

FIG. 4 is a graph of adsorption capacity of samples of the titanium-based lithium ion sieve at different time intervals during calcination, as provided according to Example 1 of the present disclosure. During continuous production, the samples of the titanium-based lithium ion sieve were taken at 5-h intervals, and acidified with hydrochloric acid to yield β-H₂TiO₃, and β-H₂TiO₃ was used for testing the adsorption capacity of the titanium-based lithium ion sieve. As can be seen from FIG. 4, a titanium-based lithium ion sieve product prepared in Example 1 had uniform performance, with an average saturated adsorption capacity of 55 mg/g, exhibiting the characteristic of large adsorption capacity.

### Example 2

The present example provided a preparation method for a titanium-based lithium ion sieve. The preparation method for a titanium-based lithium ion sieve included steps as follows.

(1) 400 kg of deionized water was added into a mixing tank, 180 kg of a lithium hydroxide powder was added under stirring, and then 420 kg of a citric acid powder was added, followed by stirring at a rotational speed of 600 rpm for 3 h, yielding a lithium citrate solution;

10 kg of PEG-600 and 280 kg of an anatase type titanium dioxide powder (with a particle size of 500 nm) were added into the lithium citrate solution, followed by stirring at 600 rpm for 4 h, yielding a feed liquid with a viscosity of 400 mPas; subsequently, the feed liquid was transferred into a ball mill, and subjected to ball milling with 8 mm-diameter zirconia beads as grinding bodies at a rotational speed of 90 rpm for 5 h; afterwards, the feed liquid was fed unidirectionally into a sand mill at a feed rate of 20 L/min and ground at a rotational speed of 1000 rpm, where a material discharged from the sand mill was collected in a separate mixing tank, and the sand milling was carried out for 10 cycles, yielding a mixed slurry of a lithium source and a titanium source;

(2) The above mixed slurry of the lithium source and the titanium source was fed onto a conveyor belt of a microwave dryer (with power of 150 kW), and the mixed slurry was dried in the microwave dryer for 1 h, where a feed rate of the mixed slurry was 100 kg/h, and a moisture content of the microwave-dried dry-state lump material was 0.5%; subsequently, the microwave-dried lump material was pulverized in a pulverizer, and sieved through a 100-mesh sieve, yielding a dry-state powder material to be calcined;

(3) The dry-state powder material to be calcined was loaded into mullite crucibles, with 4 kg in each crucible, and subjected to high-temperature calcination in a pusher kiln. A total length of the pusher kiln was 35 m. A temperature range of the pusher kiln was partitioned into four zones: a heating zone, a high-temperature reaction zone, a medium-temperature reaction zone and a cooling zone. The heating zone was partitioned into five segments, each with a length of 2.5 m, temperature settings for the five segments were 150° C., 300° C., 450° C., 600° C., and 750° C., respectively, and total residence time of the material in the heating zone was 5 h; subsequently, the material entered the high-temperature reaction zone, where the high-temperature reaction zone had only one segment, with a length of 2.5 m, a temperature setting for the high-temperature segment was 1050° C., and residence time of the material in the high-temperature zone was 1 h; afterwards, the material entered the medium-temperature reaction zone, where the medium-temperature reaction zone was partitioned into four segments, each with a length of 2.5 m, temperature settings for the four segments were 900° C., 900° C., 900° C., and 900° C., respectively, and total residence time of the material in the medium-temperature reaction zone was 4 h; then the material entered the cooling zone, where the cooling zone was partitioned into four segments, each with a length of 2.5 m, temperature settings for the four segments were 650° C., 500° C., 350° C., and 200° C., respectively, and total residence time of the material in the medium-temperature reaction zone was 4 h; and

Finally, the calcined material was pulverized in the pulverizer and sieved through a 200-mesh sieve, yielding a titanium-based lithium ion sieve powder.

FIG. 5 is an SEM photograph of the titanium-based lithium ion sieve prepared according to Example 2 of the present disclosure. As can be seen from FIG. 5, the titanium-based lithium ion sieve synthesized in the present disclosure had a particle size of 100-300 nm, which was quite small and uniform, thus being beneficial to improving the adsorption capacity of the titanium-based lithium ion sieve.

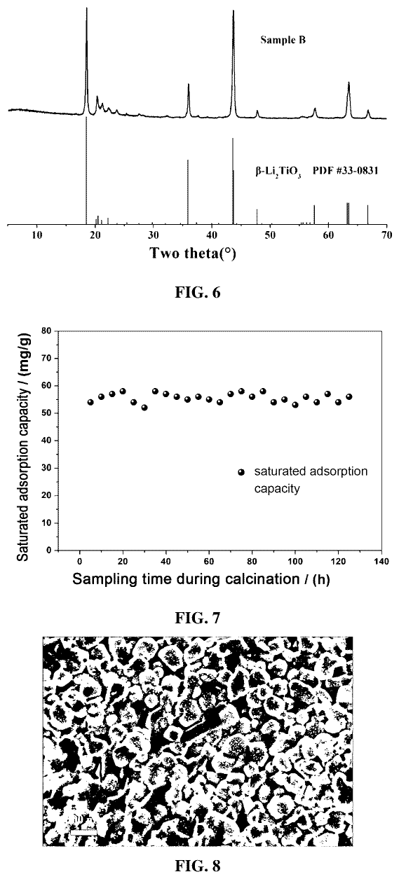

FIG. 6 is an XRD pattern of the titanium-based lithium ion sieve prepared according to Example 2 of the present disclosure. As can be seen from FIG. 6, a crystal form of the titanium-based lithium ion sieve prepared in Example 2 is β-Li₂TiO₃ crystal form, demonstrating that the titanium-based lithium ion sieve synthesized with the process in the present invention had a single crystal form, without other impurities.

FIG. 7 is a graph of adsorption capacity of samples of the titanium-based lithium ion sieve at different time intervals during calcination, as provided according to Example 2 of the present disclosure. During continuous production, the samples of the titanium-based lithium ion sieve were taken at 5-h intervals, and acidified with hydrochloric acid to yield β-H₂TiO₃, and β-H₂TiO₃ was used for testing the adsorption capacity of the titanium-based lithium ion sieve. As can be seen from FIG. 7, a titanium-based lithium ion sieve product prepared in Example 2 had uniform performance, with an average saturated adsorption capacity of 56 mg/g, exhibiting the characteristic of large adsorption capacity.

### Example 3

The present example provided a preparation method for a titanium-based lithium ion sieve. The preparation method for a titanium-based lithium ion sieve included steps as follows.

(1) 380 kg of deionized water was added into a mixing tank, 160 kg of a lithium hydroxide powder was added under stirring, and then 450 kg of an oxalic acid dihydrate powder was added, followed by stirring at a rotational speed of 350 rpm for 2 h, yielding a lithium oxalate solution;

7.5 kg of PEG-600 and 260 kg of an anatase type titanium dioxide powder (with a particle size of 100 nm) were added into the lithium oxalate solution, followed by stirring at 350 rpm for 3 h, yielding a feed liquid with a viscosity of 300 mPas; subsequently the feed liquid was transferred into a ball mill, and subjected to ball milling with 5 mm-diameter zirconia beads as grinding bodies at a rotational speed of 60 rpm for 4 h; afterwards, the feed liquid was fed unidirectionally into a sand mill at a feed rate of 15 L/min and ground at a rotational speed of 750 rpm, where a material discharged from the sand mill was collected in a separate mixing tank, and the sand milling was carried out for 8 cycles, yielding a mixed slurry of a lithium source and a titanium source;

(2) The above mixed slurry of the lithium source and the titanium source was fed onto a conveyor belt of a microwave dryer (with power of 150 kW), and the mixed slurry was dried in the microwave dryer for 0.75 h, where a feed rate of the mixed slurry was 90 kg/h, and a moisture content of the microwave-dried dry-state lump material was 0.3%; subsequently, the microwave-dried lump material was pulverized in a pulverizer, and sieved through a 80-mesh sieve, yielding a dry-state powder material to be calcined;

(3) The dry-state powder material to be calcined was loaded into mullite crucibles, with 3.5 kg in each crucible, and subjected to high-temperature calcination in a pusher kiln. A total length of the pusher kiln was 35 m. A temperature range of the pusher kiln was partitioned into four zones: a heating zone, a high-temperature reaction zone, a medium-temperature reaction zone and a cooling zone. The heating zone was partitioned into five segments, each with a length of 2.5 m, temperature settings for the five segments were 125° C., 275° C., 425° C., 575° C., and 725° C., respectively, and total residence time of the material in the heating zone was 4.5 h; subsequently, the material entered the high-temperature reaction zone, where the high-temperature reaction zone had only one segment, with a length of 2.5 m, a temperature setting for the high-temperature segment was 1000° C., and residence time of the material in the high-temperature zone was 0.9 h; afterwards, the material entered the medium-temperature reaction zone, where the medium-temperature reaction zone was partitioned into four segments, each with a length of 2.5 m, temperature settings for the four segments were 850° C., 850° C., 850° C., and 850° C., respectively, and total residence time of the material in the medium-temperature reaction zone was 3.6 h; then the material entered the cooling zone, where the cooling zone was partitioned into four segments, each with a length of 2.5 m, temperature settings for the four segments were 625° C., 475° C., 325° C., and 175° C., respectively, and total residence time of the material in the medium-temperature reaction zone was 3.6 h; and

Finally, the calcined material was pulverized in the pulverizer and sieved through a 150-mesh sieve, yielding a titanium-based lithium ion sieve powder.

FIG. 8 is an SEM photograph of the titanium-based lithium ion sieve prepared according to Example 3 of the present disclosure. As can be seen from FIG. 8, the titanium-based lithium ion sieve prepared in Example 3 had a particle size of 100-300 nm, which was quite small and uniform, thus being beneficial to improving the adsorption capacity of the titanium-based lithium ion sieve.

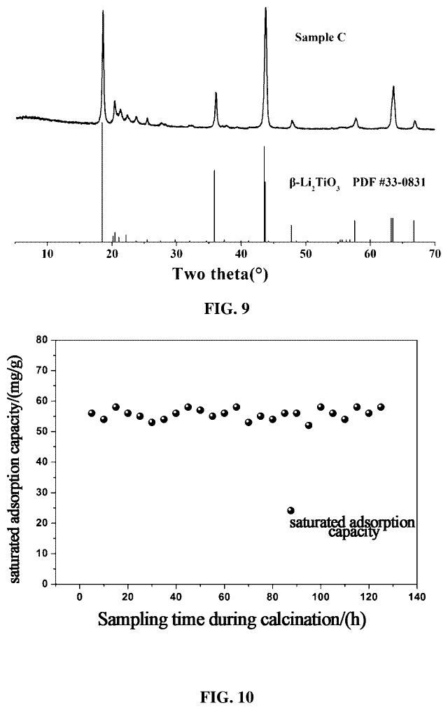

FIG. 9 is an XRD pattern of the titanium-based lithium ion sieve prepared according to Example 3 of the present disclosure. As can be seen from FIG. 9, a crystal form of the titanium-based lithium ion sieve prepared in Example 3 is β-Li₂TiO₃ crystal form, demonstrating that the titanium-based lithium ion sieve synthesized with the process in the present invention has a single crystal form, without other impurities.

FIG. 10 is a graph of adsorption capacity of samples of the titanium-based lithium ion sieve at different time intervals during calcination, as provided according to Example 3 of the present disclosure. During continuous production, the samples of the titanium-based lithium ion sieve were taken at 5-h intervals, and acidified with hydrochloric acid to yield β-H₂TiO₃, and β-H₂TiO₃ was used for testing the adsorption capacity of the titanium-based lithium ion sieve. As can be seen from FIG. 10, a titanium-based lithium ion sieve product prepared in Example 3 had uniform performance, with an average saturated adsorption capacity of 56 mg/g, exhibiting the characteristic of large adsorption capacity.

### Example 4

The present example provided a preparation method for a titanium-based lithium ion sieve, the steps of which were identical to those in Example 1, except that the titanium source in step (1) was replaced with an equal mass of metatitanic acid with a particle size D50 of 1.2 μm.

### Example 5

The present example provided a preparation method for a titanium-based lithium ion sieve, the steps of which were identical to those in Example 1, except that thickener in step (1) was replaced with an equal mass of PEG-200, obtaining the feed liquid with a viscosity of 100 mPas in step (1).

### Example 6

The present example provided a preparation method for a titanium-based lithium ion sieve, the steps of which were identical to those in Example 1, except that thickener in step (1) was replaced with an equal mass of PEG-800, obtaining the feed liquid with a viscosity of 550 mPas in step (1).

### Example 7

The present example provided a preparation method for a titanium-based lithium ion sieve, the steps of which were identical to those in Example 1, except that thickener in step (1) was replaced with an equal mass of PVA-400.

### Example 8

The present example provided a preparation method for a titanium-based lithium ion sieve, the steps of which were identical to Example 1, except that the feed rate of the mixed slurry was 60 kg/h, the drying duration was 1.5 h, and the moisture content of the material to be calcined was 0.1%.

### Example 9

The present example provided a preparation method for a titanium-based lithium ion sieve, the steps of which were identical to Example 1, except that the feed rate of the mixed slurry was 120 kg/h, the drying duration was 0.4 h, and the moisture content of the material to be calcined was 7%.

### Example 10

The present example provided a preparation method for a titanium-based lithium ion sieve, the steps of which were identical to those in Example 1, except that the temperature settings for the five segments in the heating zone were 160° C., 320° C., 460° C., 620° C., and 760° C., respectively.

### Example 11

The present example provided a preparation method for a titanium-based lithium ion sieve, the steps of which were identical to those in Example 1, except that the temperature settings for the five segments in the heating zone were 80° C., 200° C., 350° C., 500° C., and 650° C., respectively.

### Example 12

The present example provided a preparation method for a titanium-based lithium ion sieve, the steps of which were identical to those in Example 1, except for the heating zone was merely partitioned into four segments, with temperature settings for the four segments being 100° C., 300° C., 500° C., and 700° C., respectively.

### Example 13

The present example provided a preparation method for a titanium-based lithium ion sieve, the steps of which were identical to those in Example 1, except that the medium-temperature zone was partitioned into three segments, with the temperature settings for the three segments being 850° C., 850° C., and 850° C., respectively.

### Example 14

The present example provided a preparation method for a titanium-based lithium ion sieve, the steps of which were identical to those in Example 1, except that the temperature settings for the four segments in the cooling zone were 660° C., 520° C., 360° C., and 220° C., respectively.

### Example 15

The present example provided a preparation method for a titanium-based lithium ion sieve, the steps of which were identical to those in Example 1, except that the temperature settings for the four segments in the cooling zone were 580° C., 420° C., 280° C., and 120° C., respectively.

### Example 16

The present example provided a preparation method for a titanium-based lithium ion sieve, the steps of which were identical to those in Example 1, except that the cooling zone was partitioned into three segments, with the temperature settings for the three segments being 600° C., 400° C., and 200° C., respectively.

### Comparative Example 1

The present comparative example provided a preparation method for a titanium-based lithium ion sieve, the steps of which were identical to those in Example 1, except that in the mixing in step (1), the lithium citrate solution was replaced with 215.8 kg of a lithium carbonate powder.

### Comparative Example 2

The present comparative example provided a preparation method for a titanium-based lithium ion sieve, the steps of which were identical to those in Example 1, except that PEG-400 was not added in the mixing in step (1).

### Comparative Example 3

The present example provided a preparation method for a titanium-based lithium ion sieve, the steps of which were identical to those in Example 1, except that the ball milling in the ball mill was prolonged to 5 h, and the sand milling was not carried out.

### Comparative Example 4

The present comparative example provided a preparation method for a titanium-based lithium ion sieve, the steps of which were identical to those in Example 1, except that in step (2), instead of using the microwave dryer, the drying was carried out in an oven at 200° C. for 24 h, and the moisture content of the dried dry-state lump material was 3%.

### Comparative Example 5

The present comparative example provided a preparation method for a titanium-based lithium ion sieve, the steps of which were identical to those in Example 1, except that the medium-temperature reaction was not carried out after the high-temperature reaction, while the material directly entered the cooling zone, and the residence time of the material in the high-temperature zone was prolonged adaptively, specifically as follows: the high-temperature reaction zone had only one segment, with a length of 2.5 m, the temperature setting for the high-temperature segment was 950° C., and the residence time of the material in the high-temperature zone was 4 h.

### Comparative Example 6

The present comparative example provided a preparation method for a titanium-based lithium ion sieve, the steps of which were identical to those in Example 1, except that the high-temperature reaction was not carried out, the medium-temperature reaction was directly carried out after heating, the temperature of the medium-temperature zone was adaptively raised, and the residence time of the material in the medium-temperature zone was prolonged, specifically as follows: the medium-temperature reaction zone was partitioned into four segments, each with a length of 2.5 m, temperature settings for the four segments were 850° C., 850° C., 850° C. and 850° C., respectively, and the residence time of the material in the medium-temperature reaction zone was 4 h.

### Comparative Example 7

The present comparative example provided a preparation method for a titanium-based lithium ion sieve, the steps of which were identical to those in Example 1, except that thee high-temperature calcination in the pusher kiln and pulverization were omitted, while single-stage calcination was directly carried out at 800° C. for 12 h.

### Test Example 1

### Adsorption Capacity Test

Test samples: finished products of the titanium-based lithium ion sieves prepared in Examples 1-16, and finished products of the titanium-based lithium ion sieves prepared in Comparative Examples 1-7.

Testing method: placing 2 g of titanium-based lithium ion sieve agent into 1000 mL of real brine at a lithium ion concentration of 280.52 mg/L, shaking 10 h, measuring concentrations of lithium ions in the solution before and after adsorption using ICP, and calculating the adsorption capacity.

Specific test results are listed in Table 1 below.

TABLE 1

| | Adsorption |
|---|---|
| Sample | Capacity (mg/g) |
| Example 1 | 55 |
| Example 2 | 56 |
| Example 3 | 56 |
| Example 4 | 39 |
| Example 5 | 27 |
| Example 6 | 32 |
| Example 7 | 29 |
| Example 8 | 46 |
| Example 9 | 26 |
| Example 10 | 42 |
| Example 11 | 40 |
| Example 12 | 34 |
| Example 13 | 33 |
| Example 14 | 41 |
| Example 15 | 39 |
| Example 16 | 35 |
| Comparative Example 1 | 23 |
| Comparative Example 2 | 25 |
| Comparative Example 3 | 19 |
| Comparative Example 4 | 21 |
| Comparative Example 5 | 18 |
| Comparative Example 6 | 19 |
| Comparative Example 7 | 21 |

—

As evidenced from the test results in Table 1, the titanium-based lithium ion sieve products obtained through the optimal process route of the present disclosure had uniform performance, and had an average adsorption capacity of 55 mg/g or higher, exhibiting the characteristic of large adsorption capacity.

As can be seen from comparison between Example 1 and Example 4, the titanium source in the present disclosure is optionally nano titanium dioxide, and compared with the microscale metatitanic acid, the nano titanium dioxide for preparing the titanium-based lithium ion sieve had a smaller particle size, thus enabling the titanium dioxide particles to be in more sufficient contact with the water-soluble lithium source, while enabling the two materials to be mixed more uniformly, which is more beneficial to forming more lithium intercalation sites, and significantly improving the average adsorption capacity of the product.

As can be seen from comparison between Example 1 and Examples 5-6, the molecular weight of polyethylene glycol is optionally 400-600, and the average adsorption capacity was large. When the molecular weight is too low, titanium dioxide with a poor thickening effect precipitates in aqueous solution, and the two materials, i.e., the water-soluble lithium source and the titanium source, tend to stratify but are uniformly dispersed during the microwave drying; while a too high molecular weight will lead to a too high viscosity to hinder the ball milling and the sand milling, and also cause insufficient contact between the titanium dioxide particles and the water-soluble lithium source, thus resulting in non-uniform mixing.

As can be seen from comparison between Example 1 and Example 7, polyethylene glycol is optionally employed as the thickener in the present disclosure. However, when it was replaced with PVA of equal mass or molar amount, the thickening effect was suboptimal, and its effectiveness in preventing sedimentation of titanium dioxide in the aqueous solution was significantly diminished.

As can be seen from comparison between Example 1 and Examples 8 and 9, the mixed slurry should be fed to the microwave drying at the feed rate within the range of 80-100 kg/h; otherwise, even if the rate is reduced and the drying duration is prolonged, or the rate is increased and the drying duration is shortened, the drying is insufficient, and the material cannot be uniformly dispersed.

As can be seen from comparison between the Example 1 and Example 12, if the heating zone is only partitioned into four segments, the excessively rapid heating rate will hinder later more regular and complete growth of crystal nuclei, leading to reduced adsorption capacity.

As can be seen from comparison between Example 1 and Example 13, if the medium-temperature reaction zone is only partitioned into three segments, temperatures of the segments of the medium-temperature reaction zone are not within the scope of the present disclosure, and growth in the medium-temperature zone also will exhibit irregularity and defects.

As can be seen from comparison between Example 1 and Comparative Example 1, using lithium carbonate as the lithium source tends to cause the problem of non-uniform material mixing, which is particularly prominent in industrialization and scale-up production. However, in the example, the water-soluble lithium source instead of the water-insoluble lithium source (such as lithium carbonate) is used as the lithium source and mixed with the titanium source, and the water-soluble lithium source infiltrates and coats on a surface of titanium dioxide, so that the lithium source and the titanium source can be mixed more sufficiently, thus shortening a migration path of lithium ions during the reaction, and elevating the reaction rate.

As can be seen from comparison between Example 1 and Comparative Example 2, without the addition of the thickener, severe sedimentation occurs to titanium dioxide in the aqueous solution, and the two materials, i.e., the water-insoluble lithium source and the titanium source, tend to stratify and are uniformly dispersed during the microwave drying.

As can be seen from comparison between Example 1 and Comparative Example 3, without the sand milling, even with prolonged ball milling, agglomerated titanium dioxide cannot be well ground or broken up, and fails to be in sufficient contact with the water-soluble lithium source, thus compromising uniformity of the product performance.

As can be seen from the comparison between Example 1 and Comparative Example 4, using the microwave dryer for drying the liquid material can prevent the stratification or sedimentation phenomenon of the lithium citrate solution and titanium dioxide caused by prolonged drying time, thus ensuring uniform dispersion of the material and improving drying efficiency.

As can be seen from comparison between Example 1 and Comparative Examples 5-6, the pusher kiln is used in the present disclosure for sintering, the temperature range of the pusher kiln is partitioned into four zones, i.e., the heating zone, the high-temperature reaction zone, the medium-temperature reaction zone and the cooling zone, the high-temperature reaction zone features a short residence time, and all zones are indispensable, so as to solve the problem of low product performance caused by an improper sintering process during the sintering.

### Test Example 2

### Lithium Ion Extraction Test in Brine

Test samples: finished products of the titanium-based lithium ion sieves prepared in Examples 1-16, and finished products of the titanium-based lithium ion sieves prepared in Comparative Examples 1-7.

Testing method: acidifying the titanium-based lithium ion sieve β-Li₂TiO₃ manufactured in the above with a 0.5 M hydrochloric acid solution, yielding β-Li₂TiO₃; placing 2 g of β-Li₂TiO₃ in 1 L of real brine for adsorption for 10 h; filtering a powder to yield a filter cake; placing the filter cake into 1 L of the 0.5 M hydrochloric acid solution for desorption for 3 h, yielding a desorption solution; and taking samples from the desorption solution and testing concentrations of potassium, sodium, magnesium, calcium, and lithium ions therein.

Specific test results are listed in Table 2 and Table 3 below:

TABLE 2

| Element | | | | | |
|---|---|---|---|---|---|
| Concentration (mg/L) | Li⁺ | Na⁺ | K⁺ | Ca²⁺ | Mg²⁺ |
| Real Brine | 280.52 | 31207.23 | 3856.32 | 30.75 | 25.67 |
| Example 1 | 110.62 | 2.14 | 1.12 | 0.56 | 0.74 |
| Example 2 | 109.33 | 2.52 | 1.03 | 0.52 | 0.64 |
| Example 3 | 112.46 | 1.87 | 0.86 | 0.53 | 0.51 |
| Example 4 | 80.12 | 19.24 | 15.18 | 4.65 | 5.78 |
| Example 5 | 54.62 | 23.78 | 19.97 | 5.98 | 6.89 |
| Example 6 | 64.88 | 20.73 | 17.67 | 5.23 | 6.31 |
| Example 7 | 58.43 | 22.97 | 19.12 | 5.86 | 6.54 |
| Example 8 | 92.12 | 17.43 | 14.95 | 5.34 | 6.13 |
| Example 9 | 52.43 | 29.78 | 26.97 | 7.98 | 8.89 |
| Example 10 | 84.32 | 23.43 | 18.45 | 7.41 | 6.56 |
| Example 11 | 80.12 | 25.55 | 19.43 | 6.86 | 6.97 |
| Example 12 | 69.88 | 25.65 | 23.56 | 7.43 | 5.34 |
| Example 13 | 66.34 | 28.32 | 26.13 | 6.47 | 6.78 |
| Example 14 | 82.34 | 19.56 | 20.13 | 5.87 | 5.32 |
| Example 15 | 78.33 | 18.67 | 17.98 | 5.76 | 6.34 |
| Example 16 | 71.06 | 26.13 | 24.55 | 7.02 | 6.23 |
| Comparative Example 1 | 46.32 | 33.94 | 29.76 | 9.74 | 8.65 |
| Comparative Example 2 | 50.87 | 33.65 | 39.56 | 8.76 | 7.87 |
| Comparative Example 3 | 38.44 | 45.87 | 36.89 | 10.56 | 9.76 |
| Comparative Example 4 | 42.54 | 45.78 | 39.45 | 10.87 | 9.74 |
| Comparative Example 5 | 36.76 | 49.73 | 46.24 | 11.57 | 10.54 |
| Comparative Example 6 | 38.75 | 49.54 | 38.76 | 11.32 | 10.79 |
| Comparative Example 7 | 42.54 | 45.78 | 39.45 | 10.87 | 9.74 |

TABLE 3

| Element Concentration Ratio | Li⁺/Na⁺ | Li⁺/K⁺ | Li⁺/Ca²⁺ | Li⁺/Mg²⁺ |
|---|---|---|---|---|
| Real Brine | 0.009 | 0.073 | 9.18 | 10.93 |
| Example 1 | 51.69 | 98.77 | 197.54 | 149.49 |
| Example 2 | 43.38 | 106.15 | 210.25 | 170.83 |
| Example 3 | 60.14 | 130.77 | 212.19 | 220.51 |
| Example 4 | 4.16 | 5.28 | 17.23 | 13.86 |
| Example 5 | 2.30 | 2.74 | 9.13 | 7.93 |
| Example 6 | 3.13 | 3.67 | 12.41 | 10.28 |
| Example 7 | 2.54 | 3.06 | 9.97 | 8.93 |
| Example 8 | 5.29 | 6.16 | 17.25 | 15.03 |
| Example 9 | 1.76 | 1.94 | 6.57 | 5.90 |
| Example 10 | 3.60 | 4.57 | 11.38 | 12.85 |
| Example 11 | 3.14 | 4.12 | 11.68 | 11.49 |
| Example 12 | 2.72 | 2.97 | 9.41 | 13.09 |
| Example 13 | 2.34 | 2.54 | 10.25 | 9.78 |
| Example 14 | 4.21 | 4.09 | 14.03 | 15.48 |
| Example 15 | 4.20 | 4.36 | 13.60 | 12.35 |
| Example 16 | 2.72 | 2.89 | 10.12 | 11.41 |
| Comparative Example 1 | 1.36 | 1.56 | 4.76 | 5.35 |
| Comparative Example 2 | 1.51 | 1.29 | 5.81 | 6.46 |
| Comparative Example 3 | 0.84 | 1.04 | 3.64 | 3.94 |
| Comparative Example 4 | 0.93 | 1.08 | 3.91 | 4.37 |
| Comparative Example 5 | 0.74 | 0.79 | 3.18 | 3.49 |
| Comparative Example 6 | 0.78 | 1.00 | 3.42 | 3.59 |
| Comparative Example 7 | 0.93 | 1.08 | 3.91 | 4.37 |

As evidenced from the test results in Table 2 and Table 3, the titanium-based lithium ion sieve manufactured in the present patent application has extremely high selectivity for lithium ions, can selectively extract lithium ions from brine, and substantially does not adsorb potassium, sodium, magnesium and calcium ions, thus enabling a quite high ratio of lithium ions to sodium, potassium, magnesium and calcium ions in the desorption solution, that is, a high-quality lithium extraction desorption solution is obtained, and selective extraction of lithium ions from brine is achieved.

Finally, it should be noted that various examples above are merely used for explaining the technical solutions of the present disclosure, rather than limiting the present disclosure; while the detailed description is made to the present disclosure with reference to various preceding examples, those ordinarily skilled in the art should understand that they still could modify the technical solutions described in various preceding examples, or make equivalent substitutions to some or all of the technical features therein; and these modifications or substitutions do not make the essence of corresponding technical solutions depart from the scope of the technical solutions of various examples of the present disclosure.

### INDUSTRIAL APPLICABILITY

The present disclosure provides a preparation method for a titanium-based lithium ion sieve, a product prepared thereby and use, relating to the technical field of lithium ion adsorption. The preparation method for a titanium-based lithium ion sieve includes steps as follows: mixing a water-soluble lithium source, a titanium source and a thickener, and sequentially carrying out ball milling and sand milling to yield a mixed slurry of the lithium source and the titanium source; drying the mixed slurry and then carrying out pulverization, yielding a material to be calcined; and carrying out high-temperature calcination on the material to be calcined by segmentation, followed by pulverization, yielding the titanium-based lithium ion sieve, where a temperature range of the high-temperature calcination is partitioned into four zones, including a heating zone, a high-temperature reaction zone, a medium-temperature reaction zone and a cooling zone. The present disclosure aims at addressing the problem of non-uniform and low performance of the titanium-based lithium ion sieve during scale-up preparation.

Besides, it may be understood that the preparation method for a titanium-based lithium ion sieve, the product prepared thereby and the use provided in the present disclosure are reproducible, and can be applied in various industrial applications. For example, the preparation method for a titanium-based lithium ion sieve, the product prepared thereby and the use in the present disclosure can be applied to the technical field of lithium ion adsorption.

1. A preparation method for a titanium-based lithium ion sieve, comprising steps of:
(1) mixing a water-soluble lithium source, a titanium source and a thickener, and sequentially carrying out ball milling and sand milling, so as to yield a mixed slurry of the lithium source and the titanium source;
(2) drying the mixed slurry obtained in step (1) and then carrying out pulverization, so as to yield a material to be calcined; and
(3) carrying out high-temperature calcination on the material to be calcined obtained in step (2) by segmentation, followed by pulverization, so as to yield the titanium-based lithium ion sieve, wherein
a temperature range of the high-temperature calcination is partitioned into four zones, comprising a heating zone, a high-temperature reaction zone, a medium-temperature reaction zone and a cooling zone, wherein a temperature setting for the heating zone is 100-750° C., a temperature setting for the high-temperature reaction zone is 950-1050° C., a temperature setting for the medium-temperature reaction zone is 800-900° C., and a temperature setting for the cooling zone is 150-650° C.

2. The preparation method for a titanium-based lithium ion sieve according to claim 1, wherein in step (1), a mass ratio of the water-soluble lithium source, the titanium source and the thickener is (1-5):(1-5):(0.01-0.05); and
the water-soluble lithium source is a lithium citrate solution and/or a lithium oxalate solution;
optionally, the water-soluble lithium source is prepared by a method as follows: adding lithium hydroxide into water under stirring, then adding acid, and stirring to yield a water-soluble lithium source solution;
optionally, a mass ratio of the water, lithium hydroxide and acid is (3-5):(1.5-2):(3.5-4.5); and
optionally, the acid comprises citric acid and/or oxalic acid.

3. The preparation method for a titanium-based lithium ion sieve according to claim 2, wherein the lithium citrate solution is prepared through steps as follows: adding deionized water into an agitator, adding a lithium hydroxide powder under stirring, adding a citric acid powder, and stirring at a rotational speed of 100-600 rpm for 1-3 h, so as to yield the lithium citrate solution.

4. The preparation method for a titanium-based lithium ion sieve according to claim 2, wherein the lithium oxalate solution is prepared through steps as follows: adding deionized water into an agitator, adding a lithium hydroxide powder under stirring, adding an oxalic acid dihydrate powder, and stirring at a rotational speed of 100-600 rpm for 1-3 h, so as to yield the lithium oxalate solution.

5. The preparation method for a titanium-based lithium ion sieve according to claim 1, wherein in step (1), the titanium source comprises rutile type titanium dioxide and/or anatase type titanium dioxide; and
in step (1), a particle size of the titanium source is 50-500 nm.

6. The preparation method for a titanium-based lithium ion sieve according to claim 1, wherein in step (1), the thickener comprises any one selected from the group consisting of polyethylene glycol, polyvidone, polyvinyl alcohol or hydroxyethyl cellulose or a combination of at least two therefrom, optionally polyethylene glycol; and
a number-average molecular weight of the polyethylene glycol is 200-800, and further optionally 400-600.

7. The preparation method for a titanium-based lithium ion sieve according to claim 1, wherein in step (1), the lithium source, the titanium source and the thickener are mixed at a rotational speed of 100-600 rpm for 2-4 h.

8. The preparation method for a titanium-based lithium ion sieve according to claim 1, wherein in step (2), the drying is microwave drying.

9. The preparation method for a titanium-based lithium ion sieve according to claim 1, wherein in step (3), the high-temperature calcination is carried out in a pusher kiln, followed by the pulverization, so as to yield the titanium-based lithium ion sieve.

10. The preparation method for a titanium-based lithium ion sieve according to claim 1, wherein in step (3), sieving is conducted after the pulverization through a 100-200 mesh sieve.

11. A titanium-based lithium ion sieve, wherein the titanium-based lithium ion sieve is prepared by the preparation method for a titanium-based lithium ion sieve according to claim 1.

12. A method for selective recognition and/or extraction of lithium ions from brine, comprising mixing the titanium-based lithium ion sieve according to claim 11 with the brine and adsorbing lithium ions with the titanium-based lithium ion sieve.

13. The preparation method for a titanium-based lithium ion sieve according to claim 2, wherein, the water-soluble lithium source is prepared by a method as follows: adding lithium hydroxide into water under stirring, then adding acid, and stirring to yield a water-soluble lithium source solution.

14. The preparation method for a titanium-based lithium ion sieve according to claim 2, wherein a mass ratio of the water, lithium hydroxide and acid is (3-5):(1.5-2):(3.5-4.5).

15. The preparation method for a titanium-based lithium ion sieve according to claim 2, wherein the acid comprises citric acid and/or oxalic acid.

16. The preparation method for a titanium-based lithium ion sieve according to claim 7, wherein in step (1), the hall milling is carried out with zirconia beads with a diameter of 2-8 mm at a rotational speed of 30-90 rpm for 3-5 h.

17. The preparation method for a titanium-based lithium ion sieve according to claim 7, wherein in step (1), after the ball milling, a feed liquid is fed unidirectionally into a sand mill at a feed rate of 10-20 L/min for grinding.

18. The preparation method for a titanium-based lithium ion sieve according to claim 7, wherein in step (1), the sand milling is carried out at a rotational speed of 500-1000 rpm for 5-10 cycles.

19. The preparation method for a titanium-based lithium ion sieve according to claim 8, wherein in step (2), a feed rate of the mixed slurry for the microwave drying is 80-100 kg/h.

20. The preparation method for a titanium-based lithium ion sieve according to claim 8, wherein the microwave drying is carried out at a power of 100-200 kW for 0.5-1 h.
